(19) United States
(12) Patent Application Publication
(10) Pub. No.: US 2007/0230526 A1
(43) Pub. Date: Oct. 4, 2007

(54) Semiconductor laser module driven in shunt-driving configuration

(75) Inventors: Akihiro Moto, Kanagawa (JP); Katsumi Uesaka, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 11/727,414

(22) Filed: Mar. 26, 2007

(30) Foreign Application Priority Data
Mar. 29, 2006 (JP) 2006-092067

(51) Int. Cl. H01S 3/00

(52) U.S. Cl. 372/38.03

(57) ABSTRACT

The present invention is to provide a laser module stably operable with less jitter in high frequencies. The laser module of the invention provides a semiconductor laser diode and a current-shunting device that shunts the current flowing in the LD by responding the input modulation signal. A path where the current flows puts a serial circuit comprised of an inductor and a compensation circuit to compensate a ripple in the frequency response of the module. The resonance frequency of the compensation circuit corresponds to a frequency of a dip or a peak in the frequency spectrum of the module.

### BACKGROUND OF THE INVENTION

1. Field of the Invention

The present invention relates to a semiconductor laser module, in particular, the invention relates to a laser module installed with an Ld-driver.

2. Related Prior Art

Some prior documents have disclosed a semiconductor laser module with a shunt-driving configuration, where the current to be supplied with the semiconductor laser diode (Ld) is switched by a field-effect-transistor (FET) connected in parallel to the Ld. For example, a Japanese Patent Application published as JP-2005-033019A has disclosed in FIG. 4C thereof, in which the Ld is connected in parallel to an n-type FET. The cathode of the Ld and the source of the FET commonly connect to the ground, while, the anode of the Ld and the drain of the FET are biased with the Vcc through an inductor L. The gate of the FET receives a modulation signal. When the FET turns on by the modulation signal, the current from the power supply Vcc flows primarily in the FET, while, the current flows in the Ld when the modulation signal becomes the low level because the FET turns off. Thus, this type of the driver for the Ld is called as the shunt-configuration because the modulation signal supplied with the gate of the FET determines whether the current flows in the FET or the Ld.

The laser module mentioned above generally provides an inductor in the power supply line for isolating the module from high-frequency signals (RF), that is, the power supply Vcc is provided through the inductor. However, a laser module with a CAN-type package does not have enough space to install electronic components within the package. Accordingly, electronic components installed within the package are necessary to have a small size. A small-sized inductor is unable to show a large inductance, accordingly, the isolation of the high-frequency signal becomes unsatisfactory, which increases a jitter in the optical output signal.

Accordingly, the present invention is to provide a laser module that enables to emit light with less jitter.

### SUMMARY OF THE INVENTION

A semiconductor laser module according to the present invention, which has a configuration of the shunt-driving, includes a semiconductor laser diode, an electronic device, a first inductor and a compensation circuit. The electronic device switches a current to be supplied to the laser diode by responding to a modulation signal input thereto. The electronic device is connected in parallel to the laser diode in the shunt-driving configuration. The first inductor is put on a path for supplying the current to the laser diode. The compensation circuit, which is connected in serial to the first inductor, has a characteristic to compensate a frequency response of the current with respect to the modulation signal provided to the electronic device. In the present invention, the compensation circuit is serially connected to the inductor, and thus serially connected inductor with the compensation circuit is further connected in serial to the laser diode and to the electronic device.

The laser module of the present invention may provide a CAN package that includes a stem with a block and first and second lead pins. The stem mounts the laser diode, the electronic device, the first inductor and the compensation circuit. The first lead pin, which is connected to the path to supply the current, and the second lead pin is connected to the electronic circuit. The laser diode, the electronic device and the compensation circuit may be mounted on a side of the block.

### BRIEF DESCRIPTION OF DRAWINGS

FIG. 1 is a perspective view of a laser module according to an embodiment of the present invention;

FIG. 2 is an equivalent circuit diagram of the laser module shown in FIG. 1;

FIG. 3 is a frequency response, S21, of a laser module without a compensation circuit;

FIG. 4 is an impedance characteristic of the compensation circuit;

FIG. 5 is a frequency response, S21, of a laser module with the compensation circuit according to an embodiment of the present invention; and

FIGS. from 6A to 6D show various eye-diagrams.

### DESCRIPTION OF PREFERRED EMBODIMENTS

Next will describe embodiments of the present invention as referring to accompanying drawings. In the description below, the same numerals or the symbols will refer to the same elements without overlapping explanations.

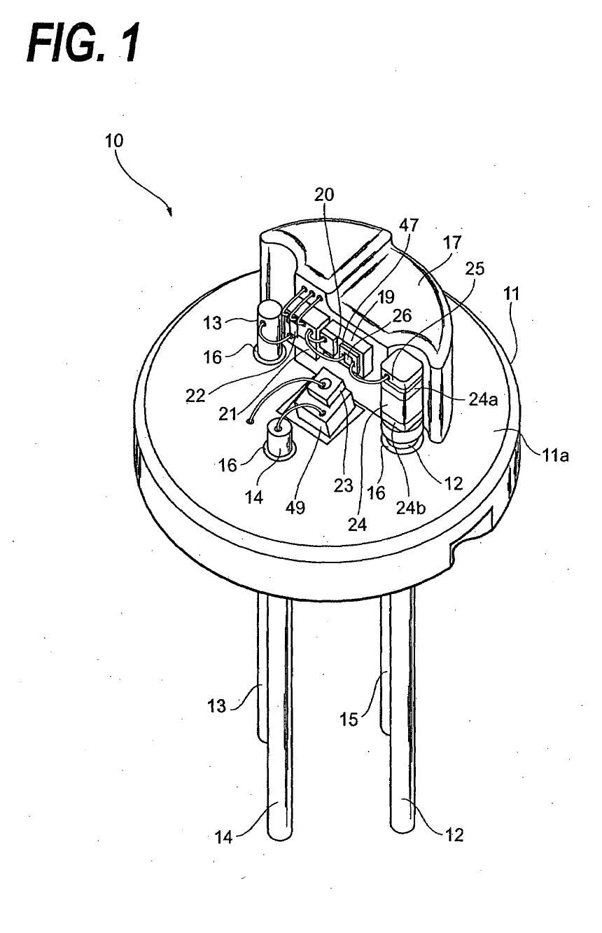

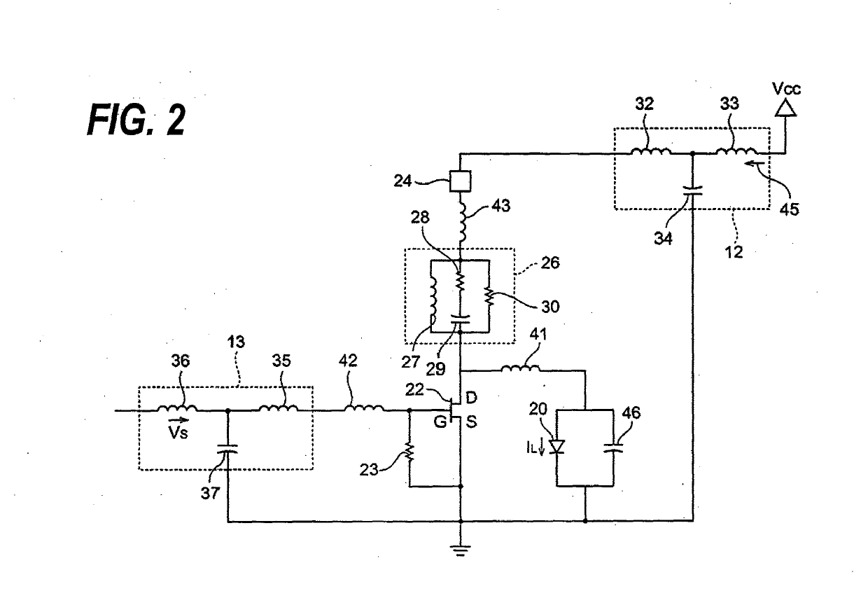

FIG. 1 is a perspective view of a laser module according to an embodiment of the present invention, while, FIG. 2 is an equivalent circuit diagram of the laser module shown in FIG. 1. The laser module 10 has a CAN-type package with a disk-shaped stem 11 and a plurality of lead pins, four pins in the present embodiment, 12 to 15. Three of pins, 12 to 14 pass through respective holes in the stem 11. Seal glass 16 fills a gap between the pin and the stem 11 to hermetically seal the package. The last lead pin 15 is resistance-welded or brazed to a back surface of the stem 11 to secure an electrical contact with the stem 11. The lead pin 15 functions as a ground pin. Here, the primary surface of the stem 11 mounts the Ld and electronic components, while, the back surface is opposite thereto.

The primary surface 11a of the stem 11 installs the Ld 20, an electronic device 21, an inductor 24 and a compensation circuit 26. The heat sink 19 made of electrically conductive material mounts the Ld 20 and the compensation circuit 26. The cathode of the Ld 20 is connected to the mount 17 through the heat sink 19. A ceramics substrate 47, which is fixed on the heat sink 19, mounts the compensation circuit 26. The electronic device 21 provides an FET 22 thereon. As shown in FIG. 1, the mount 17 is protruded on the primary surface 11a of the stem 11, and the side of the mount 17 attaches the heat sink 19 and the electronic device 21 thereto. The mount 17 is grounded via the stem 11 and the lead pin 15.

The gate of the FET 22 connects with the lead pin 13, the source thereof connects with the mount 17, while, the drain connects with the anode of the Ld with respective bonding wires. The source of the FET 22 and the cathode of the Ld 20 are commonly grounded through the mount 17, the stem 11 and the lead pin 15. Thus, the FET 22 is coupled in parallel to the Ld 20. The drain of the FET 22 also connects with the compensation circuit 26 with a bonding wire. The other terminal of the compensation circuit 26 connects with the inductor 24 with another bonding-wire.

On the primary surface 11a of the stem is disposed with a photodiode (Pd) 23 through a sub-mount 49. One of the cathode and the anode of the Pd connects with the lead pin 14 with a bonding wire, while, the other directly connects with the stem 11 with another bonding wire.

In the circuit diagram shown in FIG. 2, elements 32 and 33 show parasitic inductance of the lead pin 12, which is 0.0742 nH and 0.287 nH, respective, and the other element 34 denotes parasitic capacitance between the lead pin 12 and the stem 11, which is 0.404 pF. The elements, 35 and 36, are the parasitic inductance of the lead pin 13, 0.557 nH and 0.337 nH, respectively, while the element 37 denotes the parasitic capacitance between the lead pin 13 and the stem 11, which is 0.436 pF. The elements, 41 to 43, are the parasitic inductance attributed to the bonding wire, 0.2 nH, 0.2 nH and 2 nH, respectively, while, the element 46 is the junction capacitance of the Ld 20. The reason why the lead pins 12 and 13 have parasitic inductance different from each other is that a diameter of the lead pin 13 is smaller than that of the other lead pins to increase the impedance thereof.

When the laser module operates, the external power supply Vcc provides the DC current 45 to the module through the lead pin 12. The current 45, passing through the inductor 24 is provided with a parallel circuit comprised of the Ld 20 and the FET 22. On the other hand, the lead pin 13 provides the modulation signal Vs including high-frequency components to input in the gate of the FET 22. The FET 22, responding to this modulation signal Vs, switches the current supplied to the Ld 20. That is, when the modulation signal is high level, the FET 22 turns on to flow the primarily portion of the DC current 45 in the Ld 22, while, when the modulation signal becomes low level, the FET 22 turns off to flow the current 45 in the Ld 22 to emit light.

A termination resistor 23 with a resistance of 50Ω, which is not shown in FIG. 1, is connected between the gate and the source of the FET 22 to match the impedance of a path from the lead pin 13 to the gate of the FET 22 with the transmission impedance. The electronic device 21 may integrate this termination resistor 23. To match the input impedance of the module with the transmission impedance may suppress the attenuation and the reflection of the signal at the input, which enhances the quality of the modulation signal, thus, that of the optical signal.

The inductor 24, put on the path to flow the current 45 to the Ld 20, cuts the signal with high-frequency components, which suppresses the degradation of the optical signal due to noises with high-frequency components generated in the power supply Vcc. The inductor 24 may be a chip inductor with a type of ferrite beads inductor with laminated ceramics, or a type of coiled inductor. As shown in FIG. 1, the present embodiment connects one of terminals 24a of the inductor 24 connects the compensation circuit with a bonding wire through a metal chip 25 stacked thereon, while the other terminal 24b connects with the lead pin 12 with the conductive adhesive.

The modulation signal Vs, input in the lead pin 13, is influenced by the parasitic inductance, 35 and 36, and the parasitic capacitance 37 attributed to the lead pin 13. Because the bonding wire from the lead pin 13 to the gate of the FET 22 is quite short, the parasitic inductance attributed to this bonding wire is merely 0.2 to 0.3 nH. Because the source of the FET 22 is grounded to the mount 17 with a plurality of bonding wires, the parasitic inductance attributed to these bonding wires may be considered to be quite small.

The compensation circuit 26 is connected, as a load circuit of the FET 22, in serial to the inductor 24 on the pass 45 for the current to the Ld 20. This compensation circuit 26 is a parallel resonant circuit including an inductor 27, a capacitor 29 and two resistors, 28 and 30. Two resistors, 28 and 30, operate to relax the Q-value of the compensation circuit. The capacitor 29 connects one of the resistors 28, while, the inductor 27 connects in parallel the other of the resistor 30. The inductance of the inductor 27, the capacitance of the capacitor 29, and the resistance of the resistors, 28 and 30, may be 1 nH, 2 pF, 10Ω and 40Ω, respectively. Because the resistor is unfavorable to be connected in series with the inductor, the resistor 30 is connected in parallel to the inductor 27. The inductor may be a thin film inductor with a spiral metal pattern. The capacitance 29 may be a MIM (Metal-Insulator-Metal) capacitor where two metal plates put the insulating material therebetween. Two resistors, 28 and 30, may be general metal resistor with metal thin film.

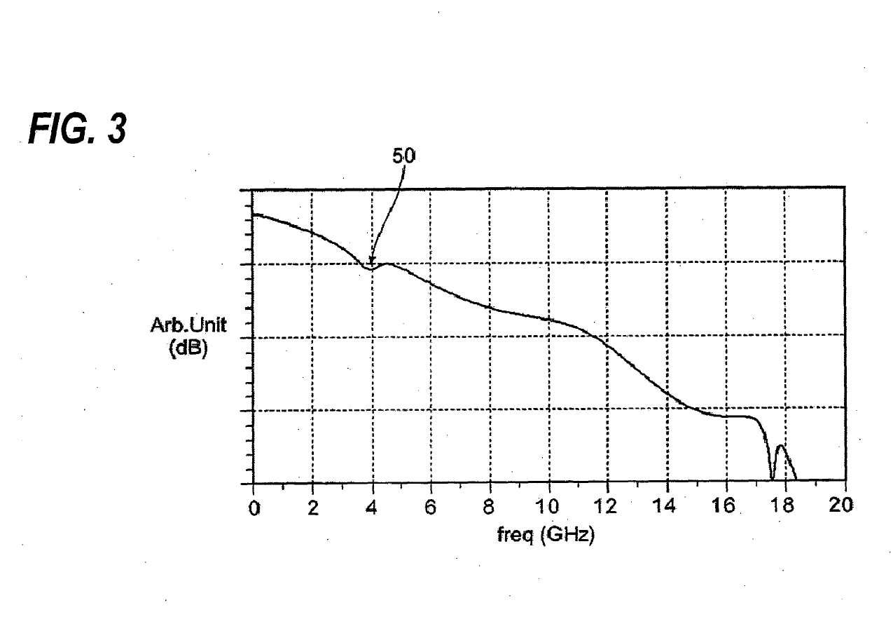

Next will describe advantages of the laser module 10 shown in FIGS. 1 and 2. FIG. 3 shows a frequency response of a laser module, where the compensation circuit shown in FIG. 2 is removed. The frequency response shown in FIG. 2 illustrates the ratio of the current I_{L} flowing in the Ld 20 to the modulation signal Vs supplied to the gate of the FET 22 without the compensation circuit 26 in FIG. 2, which corresponds to the high frequency response of the module without the compensation circuit 26. In FIG. 3, the vertical axis denotes the response in the unit of dB, while the horizontal axis denotes the frequency by the linear scale. When the horizontal axis is taken by the logarithmic axis to investigate the frequency response in low frequency regions, the response shown in FIG. 3 shows the attenuation by a slope −20 dB/oct in the high frequency region.

As shown in FIG. 3, the response appears a dip 50 around 4 GHz. The reason why the dip 50 appears is that: the pass to flow the current provides the inductor to cut the high frequency components. However, as mentioned earlier, the module with the CAN package may not retain an enough space to install a large-sized inductor. The small-sized inductor does not show enough performance to cut the high-frequency components, which results on a resonance caused by the parasitic inductance of the lead pin, the parasitic capacitance due to the seal glass of the lead pin and the parasitic capacitance attributed to the wiring patterns disposed outside of the modules. This resonance makes the dip 50 appeared around 4 GHz in the response shown in FIG. 3.

As well as the resonance described above, various factor may cause ripples in the response of the module, such as the parasitic capacitance due to the inductor 24 to cut the high frequency components, the fluctuated ground, the junction capacitance of the Ld, the life time of the carrier in the Ld and the relaxation time of the Ld 20. Here, the relaxation time is a period from time when a photon to be a seed light is generated within the cavity of the Ld to a situation when the stimulated light becomes coherent light by reiterating within the cavity. From an electrical viewpoint, the relaxation time is denoted as a period from the supplement of a pulsed signal to the Ld to obtain the laser light, which generally corresponds to a frequency with a few giga-hertz.

Because the phase drastically varies in the region where the dip appears, the dip becomes a primarily reason for causing the jitter in the optical output from the Ld 20. Although a large sized inductor, such as an inductor to cut the alternating current in relatively low frequencies, may suppress the generation of the dip, it is unfavorable to bring a large-sized package. Although an additional resistor to compensate the lack of the inductance may be disposed within the package, it is also unfavorable to increase the power dissipation, in particular, the bias voltage to provide the same bias condition to the Ld 20.

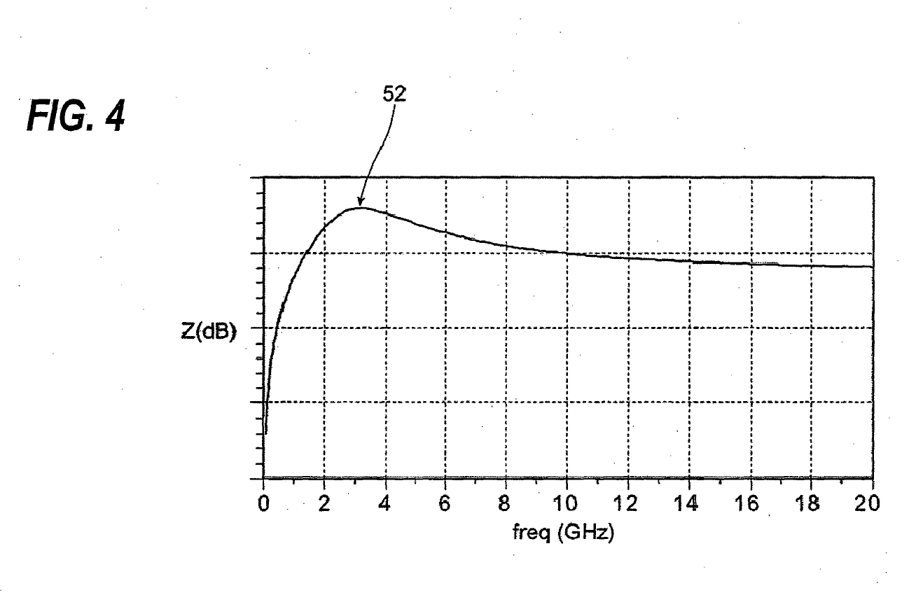

Therefore, the optical module according to the present embodiment provides the compensation circuit 26 serially connected with the inductor 24 to compensate the dip 50 in the frequency spectrum. FIG. 4 illustrates the impedance of the compensation circuit 26. The inductor 27 is regarded as that has an infinite impedance, while, the capacitor 29 is short-circuited in high frequencies. Accordingly, the composite impedance of the compensation circuit 26 becomes a parallel circuit of the resistor 28, 10Ω, and the other resistor 30, 40Ω, that is, the impedance thereof becomes 8Ω at high frequencies. On the other hand, in low frequencies, the capacitance of the capacitor 29 is regarded as infinite, while the inductor 27 is short-circuited; the composite impedance of the compensation circuit 26 becomes nearly zero, which is minus infinite in a decibel scale. In moderate frequencies, the composite impedance becomes the maximum at a frequency of ω=1/√LC, which is the resonance frequency of the inductor 27 and the capacitor 29. The resonance frequency 52 where the composite impedance becomes the maximum is about 3 GHz in the present embodiment.

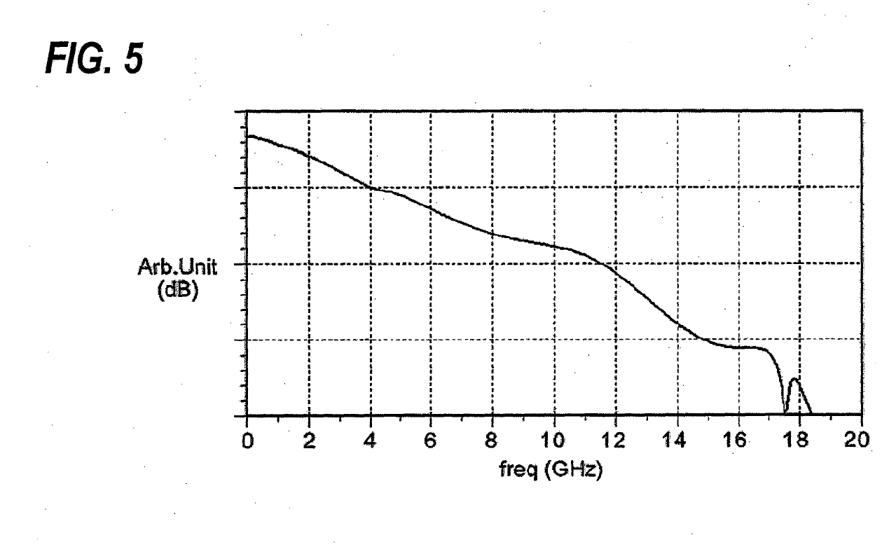

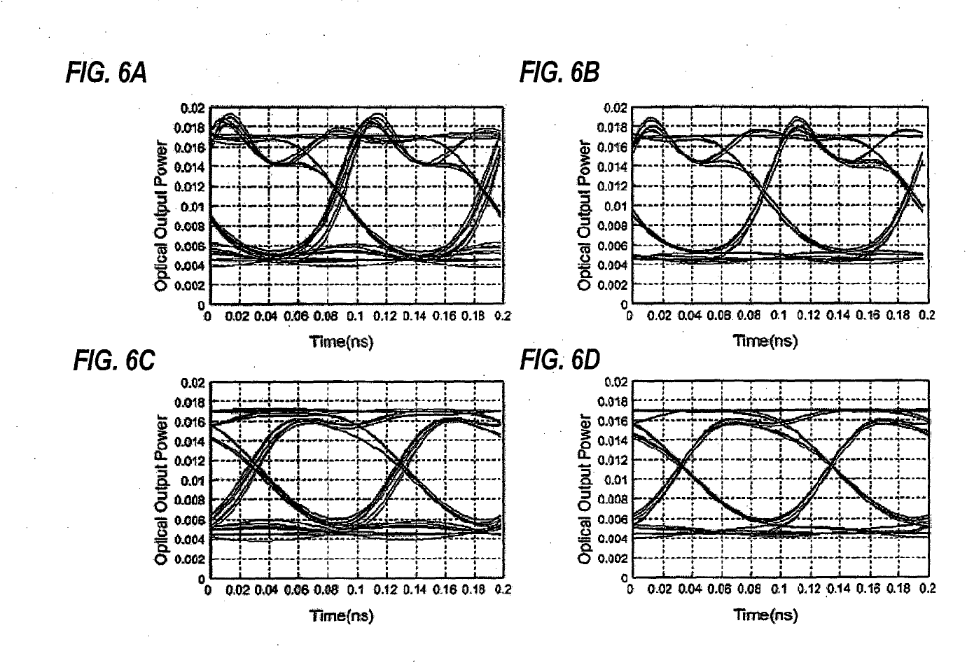

Thus, to put the compensation circuit 26, whose resonance frequency corresponds to that of the dip to be compensated, in the current path may relax the frequency undulation, such as the dip 50, because the insufficient inductance may be compensated by the circuit 26. FIG. 5 illustrates the frequency response, the current I_{L} flowing in the LD against the input modulation signal, I_{L}/V_{S}, of the laser module 10 according to the present embodiment. The dip 50 appeared around 4 GHz in the frequency response of the conventional module shown in FIG. 3 clearly disappear.

The compensation circuit 26 according to the present embodiment may reduce the jitter in the output optical signal of the LD 20. FIGS. 6A to 6D show eye-diagrams of the optical output from various modules, including the modules with the compensation circuit 26 and that without the circuit 26, for the input modulation signal of 10 Gbps. FIG. 6A is the eye-diagram of the optical output from the LD 20 without the compensation circuit 26, FIG. 6B is the case where the module provides the compensation circuit 26. These diagrams may be calculated by solving the rate equation based on the current flowing in the LD 20. The frequency response of the current respects the frequency response of the module shown previously. FIGS. 6C and 6D are eye-diagrams each obtained by receiving the optical output shown in FIG. 6A or 6B by a PD and by passing the output from the PD with a Bessel-Thomson filter. Comparing FIG. 6A with FIG. 6B, and FIG. 6C with FIG. 6D, respectively, the module with the compensation circuit 26 may clearly reduce the jitter in the optical output. The Bessel-Thomson filter may reduce the jitter of about 12 ps to about 3 ps.

Thus, the present invention is described based on embodiments and referring to accompany drawings. The invention is not restricted to those embodiments or arrangements illustrated in the drawings. It will be understood that numerous modifications thereto will appear to those skilled in the art. Accordingly, the above description and accompanying drawings should be taken as illustrative of the invention and not in a limiting sense.

For instance, although the embodiment above compensates the dip in the frequency response, the present invention may compensate the peak. Moreover, the embodiment provides the compensation circuit 26 independent of the FET 22. However, the electronic device 21 may integrate the compensation circuit 26 with the FET 22. Such electronic device 21 becomes a size of about 0.7 mm×0.7 mm. A multi-fingered configuration for the FET 22 may shrink the size of the FET 22, while, the electronic components within the compensation circuit 26 may be built within the electronic device 21 as they are. Moreover, the FET may be replaced with a bipolar transistor or other active devices for shunting the current flowing in the LD. All such changes, modifications, variations and other uses and applications which do not depart from the spirit and scope of the invention are deemed to be covered by the invention, which is to be limited only by the claims.

What is claimed is:

1. A semiconductor laser module with a shunt-driving configuration, comprising:
a semiconductor laser diode;
an electronic device connected in parallel to the laser diode, the electronic device switching a current to be supplied to the laser diode by responding to a modulation signal;
a first inductor put on a path for supplying the current to the laser diode; and
a compensation circuit connected in serial to the inductor, the compensation circuit compensating a frequency response of the current with respect to the modulation signal input to the electronic device,
wherein the compensation circuit is serially connected to the inductor and a composite circuit of the compensation circuit with the inductor is connected in serial to the laser diode and to the electronic device.

2. The laser module according to claim 1,
further comprising a CAN package including a stem for mounting the laser diode, the electronic device, the first inductor and the compensation circuit thereon, and first and second lead pins each passing through the stem,
wherein the first lead pin is connected to the path to supply the current and the second lead is connected to the electronic device to supply the modulation signal thereto.

3. The laser module according to claim 2,
wherein the first inductor is mounted on the first lead pin.

4. The laser module according to claim 2,
wherein the stem includes a mount and the laser module further includes a heat sink, and
wherein the laser diode is mounted on a side wall of the mount through the heat sink.

5. The laser module according to claim 4,
wherein the compensation circuit is mounted on the heat sink.

6. The laser module according to claim 4
wherein the electronic device is directly mounted on a side wall of the mount.

7. The laser module according to claim 1,
wherein the compensation circuit has impedance to compensate the frequency response of the current.

8. The laser module according to claim 7,
wherein the compensation circuit includes second inductor, a capacitor, and two resistors, one of which is connected in serial to the capacitor, the other of which is connected in parallel to the second inductor and to the serial circuit of the capacitor and one of the resistors.

9. The laser module according to claim 1,
wherein the compensation circuit is integrated in the electronic device.
